(19) United States
(12) Patent Application Publication
(10) Pub. No.: US 2025/0149799 A1
(43) Pub. Date: May 8, 2025

(54) RADOME WITH A SURFACE VARYING REFRACTION ANGLE FOR PHASED ARRAY ANTENNA

(71) Applicant: SAINT-GOBAIN PERFORMANCE PLASTICS FRANCE, CHARNY OREE DE PUISAYE (FR)

(72) Inventors: Riccardo CACOCCIOLA, AUBERVILLIERS (FR); Nicolas MIELEC, AUBERVILLIERS (FR); Florian BIGOURDAN, AUBERVILLIERS (FR); Emmanuel MIMOUN, AUBERVILLIERS (FR); Flavien FREMY, NORTHBOROUGH, MA (US); Shah Nawaz BUROKUR, PALAISEAU (FR); Badr Eddine RATNI, ANTONY (FR)

(21) Appl. No.: 18/836,461

(22) PCT Filed: Feb. 6, 2023
(86) PCT No.: PCT/EP2023/052765

§ 371 Date: Aug. 7, 2024

(30) Foreign Application Priority Data
Feb. 11, 2022 (EP) 22156417.2

(51) Int. Cl. H01Q 15/00; H01Q 1/40; H01Q 21/06

(52) U.S. Cl. CPC H01Q 15/0086; H01Q 1/405; H01Q 21/061

(57) ABSTRACT

A dadome with a surface varying refraction angle for phased array antennas, includes an electromagnetic wave active area which consists of a dielectric substrate and two dual-polarized meta-surfaces. The dual-polarized meta-surfaces are made of plurality of periodically arranged metallic meta-atoms with open, rotational symmetric, and non-continuous geometrical patterns. The meta-atoms overlap complementarily between the two sides of the dielectric substrate and are periodically arranged into at least two groups covering a space region the angular radiation pattern of a planar array antenna. The geometric dimensions of the meta-atoms vary within each group so that to form an electromagnetic transmissive phase gradient within that group and different from one group to another. The periodicity Δp of the meta-atoms is between λ/4 and λ/1.3, λ being the wavelength of an incident electromagnetic wave from a planar array antenna.

### TECHNICAL FIELD

The present disclosure pertains to a radome with a surface varying refraction angle. Said radome is adapted for phased array antennas.

### TECHNICAL BACKGROUND

Phased array antennas are now a technology of choice for various telecommunication and detection systems, e.g. space probes, weather forecasting systems, radar systems, AM/FM broadcasting systems and in high-frequency communication system, e.g. 5G technology standard for broadband cellular networks.

Phased array antennas are radiating systems that are based on interference of electro-magnetic waves, i.e. a phase-dependent superposition of several radiation sources to create a beam of radio waves that can be steered to point in different directions without mechanically moving the antennas themselves. They allow high gain with relatively low side-lobe attenuation, fast tuning of the beam direction, arbitrary space scanning and simultaneous generation of multiple electromagnetic beams.

A phased array antenna is usually planar and made of an array or a matrix of antenna elements each of which having their own electrically controlled phase-shifter or time-delayer and may be provided with variable amplitude control for pattern shaping. A same outgoing electromagnetic signal provided by a common transmitter is sent to each antenna element and is phase shifted or time-delayed with a given phase-shift or time-delay value before being reemitted as phase-shifted or time-delayed individual electromagnetic waves. The individual electromagnetic waves are then superimposed to create a planar electromagnetic wave travelling in a specific direction depending on the phase relationship of each phase shifter.

The scanning range of phased array antennas is often limited to be within −60° to +60°. To extend a scanning angle of the output beam beyond 60°, it is a common practice to surface functionalize the radomes, weatherproof dielectric domes, set behind or in front of a phases array antennas. Among the current surface functionalization methods, there are meta-surfaces, which provide promising results.

Meta-surfaces are the 2D counterpart of 3D metamaterials which are 3D periodic composite structures (either dielectric/metallic or fully dielectric) whose material properties can be engineered to include small heterogencities in the bulk in order to provide artificial, i.e. non available in nature, material properties. They are 2D structures made of individual cells, or meta-atoms, periodically replicated in the X and Y planes. Both meta-surfaces and metamaterials may allow to manipulate, e.g., blocking, absorbing, enhancing, and/or bending, an incident electromagnetic radiation with an effective macroscopic behaviour.

WO 2019 165684 A1 [CHANGSHU ZJU INSTITUTE FOR OPTO ELECTRONIC TECH COMMERCIALIZATION IOTEC [CN]] Jun. 9,2019 discloses a radome comprising two parallel planar meta-surfaces. The first meta-surface acts as a convex lens and the second one acts as concave lens. The focal lengths and the distance between the two meta-surfaces depend on the wavelength and the incident angle of the incident electromagnetic radiation. The scanning range of a phased array antenna may be extended from a −60° to 60° range to a −90° to 90 range.

Xue et al., Ultrathin Dual-Polarized Huygen's Metasurface: Design an Application, Annalen der Physik (Berlin), 532 (7), 2020, discloses a radome comprising dual-polarized Huygens' meta-surfaces on both sides of a dielectric substrate. The dual-polarized Huygens' meta-surfaces are made of plurality of periodically arranged metallic meta-atoms with open, rotational symmetric, and non-continuous geometrical patterns which partially overlaps between the top and bottom sides of the substrate. The radome is adapted to standard horn antenna and provides a high transmission amplitude and near 360° phase shift for the kind of said antenna.

Lv et al., Scanning range expansion of planar phased arrays using metasurfaces. IEEE Transactions on Antennas and Propagation, 68 (3), 2020, discloses a radome comprising three layered meta-surfaces distributed on the facing surfaces of two stacked planar dielectric substrates. The meta-surfaces are made of plurality of metallic meta-atoms with symmetric and continuous geometric patterns which fully overlaps and are homocentric between the facing surfaces the stacked substrate. The meta-atoms are arranged into periodically distributed groups in which the geometric dimensions of the meta-atoms vary to provide a phase transmission gradient. The radome allows to extend the scanning range of a phased array antennas by 20° in the two radiating directions.

Lec et al., Single-layer phase gradient mmWave metasurface for incident angle independent focusing, Scientific Reports 11:12671, 2021, discloses a single dielectric substrate with two metallic metasurfaces. The metasurfaces are made of plurality of periodically arranged metallic meta-atoms with open, rotational symmetric, and continuous geometrical patterns. The meta-atoms partially overlap between the two sides of the dielectric substrate and are arranged into a non-periodical layout to form an electromagnetic wave focusing lens.

CN 111 834 752 A UNIV GUANGXI SCI & TECHNOLOGY 27.10.2020 describes a Huygens meta-surface microstrip dual-polarization transmission array. The array is a single dielectric substrate with two metallic meta-surfaces. Each meta-surface is made of a plurality of periodically arranged metallic meta-atoms, each meta-atom consisting of a metallic cell with open, rotational symmetric, and non-continuous geometrical patterns. The meta-atoms overlap to form a complete and closed pattern when the patterns are superimposed in a plane parallel to the two surfaces of the dielectric substrate. They are also periodically arranged into groups in which the geometric dimensions of the meta-atoms vary to form an electromagnetic transmissive phase gradient different within each group.

### SUMMARY OF THE INVENTION

### Technical Problem

Main limitation of current radomes is that they do not allow to refract an incident electromagnetic wave with a varying refractive angle depending on its incident location onto the surface of the radomes. The radomes act the same on the incident wave wherever said wave interacts with their surface, and the scanning range may be extended for certain incident angle. Further, for certain subranges of scanning angles, the incident electromagnetic wave may be inconveniently, e.g., randomly, or noisily, refracted depending on the incident angle.

In some applications, this lack of uniform refraction behavior may be an important drawback when the scanning range is to be extended differently depending on incident angle or, indirectly, on the location of radome in respect to the planar antenna. For instance, large incident angles may not be extended enough. Further, current radomes do not allow fine tuning of the refractive angle depending on the incident location of the incident electromagnetic wave onto the radome surface.

Some issues may also arise for radome provided with complex shapes, e.g., geodesic, ogival, dish . . . as the incident angle may vary because of the curvature of the radome surface. The scanning range may not be extended uniformly over the whole surface of the radome.

Another limitation of current radomes is that they may rely on complex designs which often require stacks of several dielectric substrates sandwiching multiple meta-surfaces and/or metasurfaces with peculiar layout for the arrangement of their meta-atoms in order to provide phase transmission gradients acting as different focusing surfaces.

There is a need for a simplified radome structure allowing a fine surface varying refractive angle depending on the location on the surface of the radome.

### Solution to the Technical Problem

There is provided a radome with a surface varying refraction angle. More precisely, there is provided a radome as described in claim 1, dependent claims being advantageous embodiments.

### Advantages of the Invention

An outstanding advantage of a radome according to the disclosure is that the radome may refract a varying refractive angle depending on the incident angle. Also, a scanning range of a planar phased array antenna may be extended differently for different subranges of said scanning range.

The radome may also have a simpler design comparing to current radome and may allow to form a radome with a more complex shape.

### BRIEF DESCRIPTION OF DRAWINGS

FIG. 1 is a schematic representation of an example radome for a planar phased array antenna with an electromagnetic wave active area.

FIG. 2 is a schematic representation of the active area of a radome with two dual-polarized meta-surfaces disposed on both sides of a dielectric substrate.

FIG. 3 is a schematic representation of the meta-atoms of a first side of dielectric substrate from an active area.

FIG. 4 is a schematic representation of the meta-atoms of a second side of dielectric substrate from an active area.

FIG. 5 is a schematic representation of superimposed meta-atoms on both sides of a dielectric substrate of an active area.

FIG. 6 is a schematic representation of the electromagnetic wave active area of one embodiment of a radome according to the disclosure.

FIG. 7 is a schematic representation of the electromagnetic wave active area of second embodiment of a radome according to the disclosure.

FIG. 8 is a schematic representation of the electromagnetic wave active area of third embodiment of a radome according to the disclosure.

FIG. 9 is a schematic representation of of the meta-atoms of a first side of a region from the electromagnetic wave active area of [FIG. 6], [FIG. 7] and [FIG. 8].

FIG. 10 is a schematic representation of of the meta-atoms of a second side of a region from the electromagnetic wave active area of FIG. [FIG. 6], [FIG. 7] and [FIG. 8].

FIG. 11 is a far-field radiation pattern of a planar phased array antenna with a radome according to a first example embodiment.

FIG. 12 is a far-field radiation pattern of a planar phased array antenna with a radome according to a second example embodiment.

FIG. 13 is a far-field radiation pattern of a planar phased array antenna with a radome according to a third example embodiment.

FIG. 14 is a far-field radiation pattern of a planar phased array antenna with a first counter example of a radome which is not according to the disclosure.

FIG. 15 is a far-field radiation pattern of a planar phased array antenna with a first counter example of a radome which is not according to the disclosure.

### DETAILED DESCRIPTION OF EMBODIMENTS

In the context of the disclosure, the adjective ‘open’ or ‘closed’ when they used to qualify a shape, a figure or a pattern, ought to be interpreted according to the common definition in geometry for open shapes or figures. Open shapes, figures or patterns are shapes, figures, or patterns with different starting and ending points, i.e., the starting point and the ending point does not meet. Closed shapes, figures, or patterns are shapes, figures or patterns that have the same starting and ending points

In the context of the disclosure, a meta-surface refers to a 2D structure made of sized electrical individual cells, also called meta-atoms, periodically replicated as a lattice in a plane. The size of meta-atoms is smaller than the wavelength of the incident electro-magnetic radiation. They may be millimetric-, or micro- or nano-sized meta-atoms, depending on the wavelength of the incident electromagnetic radiation.

Owing to its periodic structure and geometrical dimensions of its electrical meta-atoms, i.e., 2D plasmonic electric dipoles acting as LC resonators, a meta-surface, when exposed to an electromagnetic radiation, acts as a grid of resonators for given frequencies of said electromagnetic radiation.

A fundamental, and well-known, parameter of a meta-surface is its resonant frequency whose value is tuned by the geometric dimensions and the periods of the meta-atoms. In radome applications, the resonant frequency often corresponds to the operating free space frequency of the radar or antenna.

An omnidirectional antenna, e.g., whip antenna, radiates in all direction of its surrounding space. On contrary, with a directional antenna, such as a planar phased array antenna, the radiations are concentrated into some directions of the space. The directions to which an antenna may radiate may be represented through the angular radiation pattern.

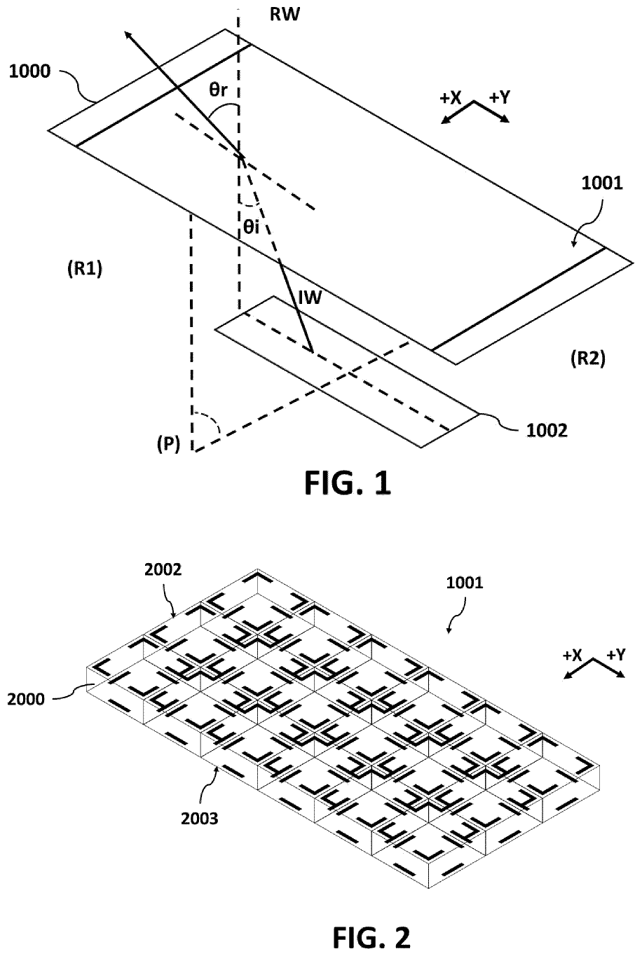

With reference to [FIG. 1], the angular radiation pattern of the planar phased array antenna 1002 may be, for instance, split in two space regions R1, R2 by a virtual perpendicular plane P corresponding to the direction of the 0° incident angle of the radiation beam. The angular radiation pattern may be split in more regions, e.g., three or four regions, depending on the radiation characteristics of the planar phased array antenna 1002.

As depicted on the illustrative [FIG. 1], a radome 1000 may be set in front of the antenna 1002 to extend the scanning range of said antenna. It may have an electro-magnetic wave active area 1001 which is designed to interact within part or all the space regions R1, R2 of the angular radiation pattern of the antenna. The active area 1001 of radome 1000 may stretch in two symmetric directions, +Y and −Y, corresponding to these two regions R1, R2. The radome may also stretch in the perpendicular direction X so that to expand into a virtual plane defined by both directions X, Y and covering the whole useful area of the radiating space regions R1, R2 of the antenna 1002.

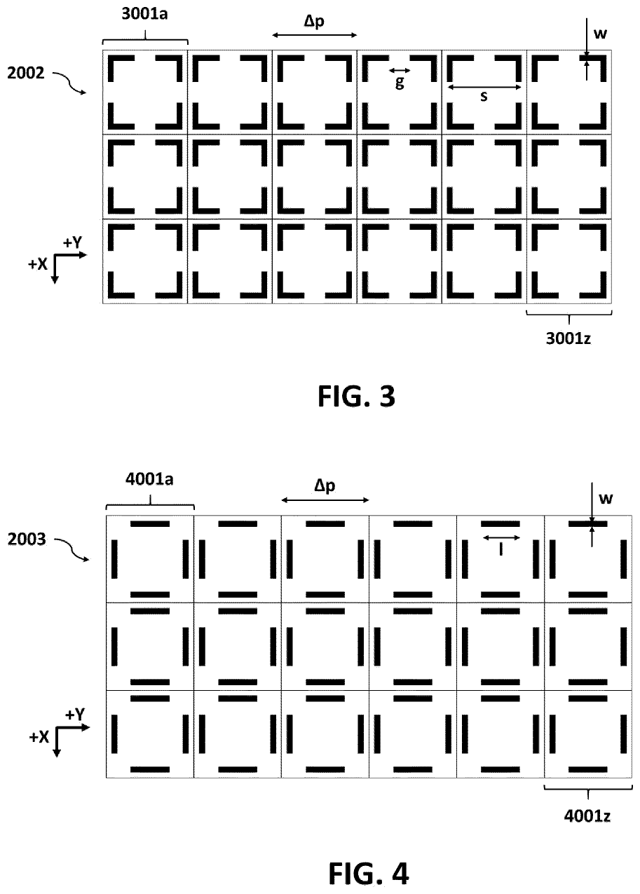

With reference to [FIG. 2], [FIG. 3] and [FIG. 4], the active area 1001 of the radome 1000 may be made of a dielectric slab or substrate 2001 with two dual-polarized meta-surfaces 2002, 2003 disposed on both sides 2001a, 2001b of a dielectric substrate 2001. The meta-surfaces 2002, 2003 may be made of a plurality of metallic meta-atoms 3001a-z, 4001a-z with open, rotational symmetric, and non-continuous geometrical patterns. The meta-atoms may be arranged with a given period, Δp, and their pattern may be defined by given geometric dimensions or parameters (l,s,g,w).

On the figures, the geometric dimensions or parameters (l,s,g,w) of the meta-atoms patterns are represented for open sided squares on the top surface 2002 and open angle squares on the bottom surface 2003. For the open sided squares, g is the gap length on the open sides, s is the side length of the squares and w is the width of the lines. For the open angle squares, 1 is the line length and w is the width of the lines.

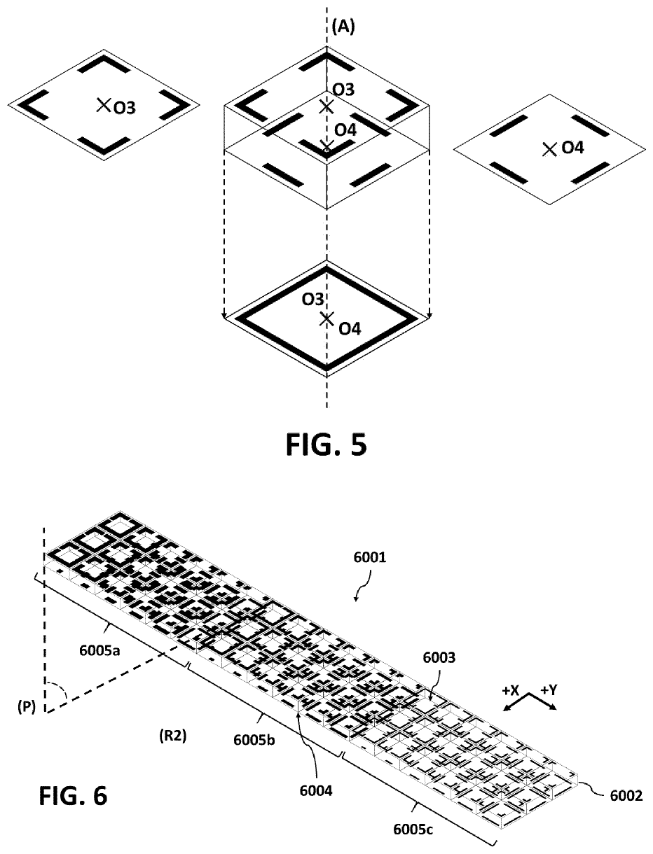

As illustrated on [FIG. 2], the meta-atoms 3001a-z, 4001a-z may partially overlap between the two sides 2001a, 2001b of a dielectric substrate 2001. With reference to [FIG. 5], the meta-atoms 3001a-z, 4001a-z may face each other on each side 2001a, 2001b of the dielectric substrate 2001 with their centres O3, O4 of rotation being coincident along an axis (A). Parts of the pattern of the meta-atoms 3001a-z on one side 2001a may cover areas of the substrate whose corresponding ones on the other side 2001b are not covered by the pattern of the meta-atoms 3001a-z on that side 2001b. Preferably the patterns of the meta-atoms 3001a-z are at least complementary to pattern the meta-atoms 4001a-z so that to form a complete and closed pattern, e.g. a closed square, when the patterns are superimposed through the dielectric substrate.

In operation, i.e., upon oncoming radiation from the planar phased array antenna 1002, the active area 1001 of the radome 1000 refracts the incident electro-magnetic waves I according to the generalized Snell-Descartes' law.

$${n}_{i} sin {θ}_{i} - {n}_{r} sin {θ}_{r} = \frac{λ}{{2}_{7 Γ}} \frac{Δ ϕ}{Δ p}$$

where θi is the incident angle of the incident electromagnetic wave IW, θr is the refractive angle of the refracted electromagnetic wave RW, ni the refractive index of the medium below the meta-surface 2002, nr the refractive index of the medium above the meta-surface 2003, λ is the wavelength of the incident electromagnetic wave IW from the planar array antenna, Δφ the phase difference between two adjacent meta-atoms 3001a-z, 4001a-z of the meta-surfaces 2002, 2003 and Δp the period of the meta-atoms 3001a-z, 4001a-z of the meta-surfaces 2002, 2003. Because the meta-surfaces 2002, 2003 have negligible thickness and the medium on both sides of the radome is air, the refractive index ni and nr are deemed to be equal to 1.

The ratio

$$\frac{Δϕ}{Δ p}$$

is called the phase gradient, grad φ. According to the generalized Snell-Descartes' law, for a given wavelength and a given incident angle θi, the value of the refracting angle θr depends on the phase gradient, grad φ.

As exemplified on [FIG. 2], [FIG. 3] and [FIG. 4], the meta-surfaces 2002, 2003 are made of meta-atoms 3001a-z, 4001a-z with pattern which geometrical dimensions that does not vary. Their phase gradient, grad φ, is zero. The radome 1000 then interacts the same way with the incident wave wherever said wave hits the surface. The scanning range is extended differently depending on the incident angle.

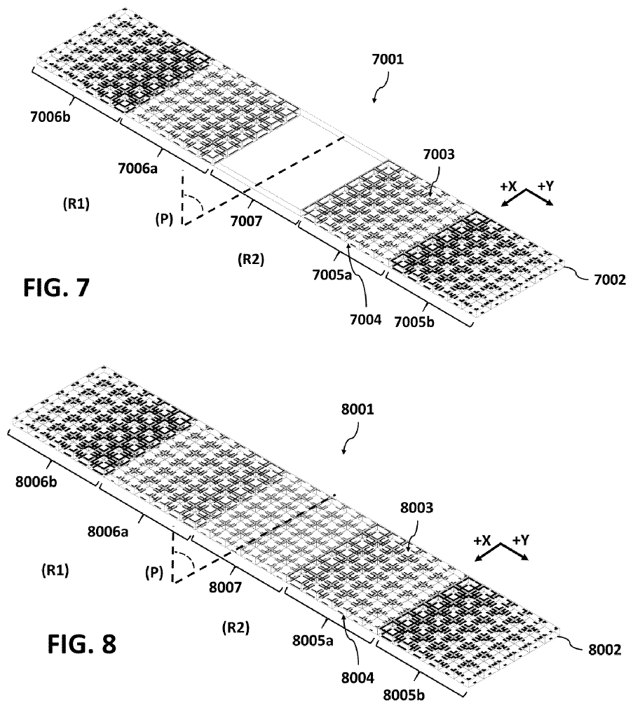

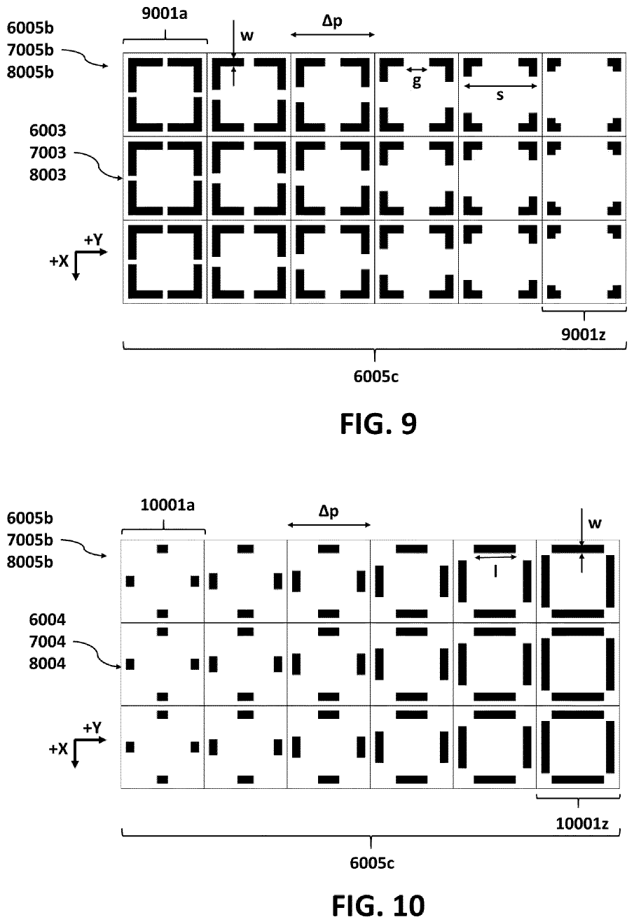

According to the present disclosure, with reference to [FIG. 6], [FIG. 7], [FIG. 8], [FIG. 9], [FIG. 10] there is provided a radome for a planar array antenna 1002,
wherein said radome comprises at least an electromagnetic wave active area 6001, 7001, 8001;
wherein said electromagnetic wave active area 6001, 7001, 8001 consists of a dielectric substrate 6002, 8002, 9002 and two dual-polarized meta-surfaces 6003, 6004, 9003, 9004, 10003, 10004 disposed on both sides of the dielectric substrate 6002, 8002, 9002;
wherein the said dual-polarized meta-surfaces 6003, 6004, 7003, 7004, 8003, 8004 are made of plurality of periodically arranged metallic meta-atoms 9001a-z, 10001a-z, each meta-atom consisting of a metallic cell with open, rotational symmetric, and non-continuous geometrical patterns;
wherein said meta-atoms 9001a-z, 10001a-z overlap to form a complete and closed pattern when the patterns are superimposed in a plane parallel to the two surfaces of the dielectric substrate 6002, 7002, 8002;
wherein said meta-atoms 9001a-z, 10001a-z are periodically arranged into at least two 6005a-6005b, 7005a-7005b, 8005a-8005b preferably three, groups 6005a-6005c covering all or part R1, R2 of the angular radiation pattern of the planar array antenna 1002;
wherein the geometric dimensions (l,s,g,w) of the meta-atoms 9001a-z, 10001a-z vary within each group 6005a-6005b, 7005a-7005b, 8005a-8005b so that to form an electromagnetic transmissive phase gradient within that group,
wherein said transmissive phase gradient is different from one group 6005a-6005b, 7005a-7005b, 8005a-8005b to another 6005a-6005b, 7005a-7005b, 8005a-8005b;
wherein the periodicity Δp of the meta-atoms 9001a-z, 10001a-z is between, λ/10 and λ, preferably between λ/4 and λ/1.3, preferably between λ/2.8 and λ/1.6
wherein λ is the wavelength of an incident electromagnetic wave IW from the planar array antenna 1002.

The geometric dimensions or parameters (l,s,g,w) of the meta-atoms 9001a-z, 10001a-z vary within each group 6005a-6005b, 7005a-7005b, 8005a-8005b and the meta-atoms 9001a-z, 10001a-z may overlap complementarily between the two sides of the dielectric substrate 6002, 7002, 8002.

Parts of the pattern of the meta-atoms 9001a-z on one meta-surface 6003, 7003, 8003 may cover areas of the substrate 6002, 7002, 8002 whose corresponding ones on the other meta-surface 6003, 7003, 8003 are not covered by the pattern of the meta-atoms 10001a-z on that side. Similar to what was illustrated in the context of [FIG. 5], the patterns of the meta-atoms 9001a-z may be complementary to the patterns of the meta-atoms 10001a-z so that to form a complete and closed pattern, e.g., a closed square, when the patterns are superimposed through the dielectric substrate 6002, 7002, 8002. In other words, said meta-atoms 9001a-z, 10001a-z overlap to form a complete and closed pattern when the patterns are superimposed in a plane parallel to the two surface of the dielectric substrate 6002, 7002, 8002.

This is exemplified on the illustrating embodiments of [FIG. 9] and [FIG. 10]. The gap length, g, may increase from left to right for the pattern of the meta-atoms 9001a-z on the first meta-surface 6003, 7003, 8003 while the line length, l, may increase complementarily on the second meta-surface 6004, 7004, 8004 so that to form a complete and closed pattern, e.g., a closed square, when the patterns are superimposed through the dielectric substrate 6002, 7003, 8003.

As illustrated on [FIG. 6], [FIG. 7], [FIG. 8], [FIG. 9] and [FIG. 10], the geometric dimensions or parameters (l,s,g,w) of the meta-atoms 9001a-z, 10001a-z may vary within each group 6005a-6005b, 7005a-7005b, 8005a-8005b in one direction, +Y, so that to form an electromagnetic transmissive phase gradient, grad φ. The meta-atoms, within a group 6005a-6005b, 7005a-7005b, 8005a-8005b, may be organised into rows or columns according to this direction +Y. The number of rows or columns in the perpendicular direction +X, −X, is a matter of design of the radome and may depend on its size and the size of its active area.

The transmissive phase gradient, grad φ, within a group 6005a-6005b, 7005a-7005b, 8005a-8005b may be positive, negative, or alternating over said group. The variations in geometric dimensions of the meta-atoms 9001a-z, 10001a-z may be adapted according to the absolute-value norm and the sign, e.g., plus or minus, of the transmissive phase gradient, grad φ.

The number of meta-atoms 9001a-z, 10001a-z within a group 6005a-6005b, 7005a-7005b, 8005a-8005b may depend on the absolute value of the transitive phase gradient grad q and on the geometric dimensions (l,s,g,w) of the patterns of meta-atoms 9001a-z, 10001a-z. In some practical embodiments, the number of meta-atoms 9001a-z, 10001a-z within a group 6005a-6005b, 7005a-7005b, 8005a-8005b may be the ratio between 2π and the phase difference, Δφ, in radians of the transmissive phase gradient, grad φ.

On [FIG. 6], the active area 6001 is represented as stretching into one direction +Y and covering only one space region R2 of the angular radiation pattern of the planar array antenna 1002. Such arrangement may be used, for instance, for planar phased array antenna which is configured to emit in one region R2 of its surrounding space, i.e., its radiation pattern is concentrated in this region of space.

For a planar phased array antenna which has a radiation pattern extending into several space regions, e.g., in two regions R1, R2, the active area of the radome may be symmetrically replicated along two directions-Y, +Y corresponding to these two regions R1, R2 of the angular radiating pattern. Such replication is illustrated in embodiments of [FIG. 7] and [FIG. 8], the groups 7006a-7006b, 8006a-8006b covering the region R1 are reflectional symmetric in −Y direction of the groups 7006a-7006b, 8006a-8006b covering the region R2 in +Y direction in respect to the (P) plane.

In some embodiments, the groups 6005a-6005b, 7005a-7005b, 7006a-7006b, 8005a-8005b, 8006a-8006b may be adjacent to each other or separated by areas with no meta-surface and/or meta-surfaces with no transmissive phase gradient. In the illustrative embodiment of [FIG. 7], the groups 7005a-7005b, 7006a-7006b are separated by a dielectric area 7007 with no meta-surface. In the illustrative embodiment of [FIG. 8], the groups 8005a-8005b, 8006a-8006b are separated by a dielectric area 8007 with a meta-surface with no transmissive phase gradient.

With reference to [FIG. 6], in preferred embodiments, the meta-atoms 9001a-z, 10001a-z may be arranged in at least three groups 6005a-6005c, wherein the phase difference Δp of the transmissive phase gradient, grad φ, is between 0° and 30° for the first group 6005a, between 30° and 40° for the second group 6005b and between 40° and 50° for the third group 6005c, and wherein the first, second and third group 6005a-6005c are located along the said radome so that the incident angle of a planar array antenna is respectively between 0° and 15°, 15° and 30° and 30° and 45° for the first, second and third group 6005a-6005c. With this arrangement, the radome may provide varying refractive angle that suit most planar phased array antenna while keeping the complexity of the design of the radome relatively low.

The pattern of the meta-atoms may be any suitable 2D geometric surface pattern, e.g. a polygonal pattern, such as a square or a rectangle, a circular pattern such as a circle or an ellipse, or a more complex pattern, such as polygonal loop or circular loop.

In preferred embodiments, as illustrated on [FIG. 6], [FIG. 7], [FIG. 8], [FIG. 9] and [FIG. 10], the pattern of the meta-atoms 9001a-z of the first meta-surface 6003, 7003, 8003 may be open sided square and the pattern of the meta-atoms 10001a-z of the second meta-surface 6004, 7004, 8004 may be open angle square.

Regarding the pattern of the meta-atoms 9001a-z of the first meta-surface 6003, 7003, 8003, in example embodiments, the side length, s, of the square segments may be between λ/200 and λ/20, preferably between λ/100 and λ/40, wherein λ is the wavelength of the incident electromagnetic wave IW from the planar array antenna 1002.

Regarding the pattern of the meta-atoms 10001a-z of the first meta-surface 6004, 7004, 8004, in example embodiments, the length of the segments of the open angle square is between λ/5 and λ/1.4, preferably between λ/4.7 and λ/1.8, wherein λ is the wavelength of the incident electromagnetic wave IW from the planar array antenna 1002.

The meta-atoms may be made of any metal. In some preferred embodiments, the meta-atoms 9001a-z, 10001a-z may be made of copper or alloyed copper. They may be formed with any adapted methods. In example embodiments, the meta-atoms may be printed with 3D or 2D printing methods, e.g. inkjet printing methods, screen printing. It may also be deposited through photolithographic, or sputtering methods, or chemical etching.

On the illustrative figures, the active area 6001, 7001, 8001 of the radome 1000 is represented as planar. In some embodiments, it may have more complex shape e.g., geodesic, ogival, dish. The dielectric substrate 6002 may be an assemblage of several dielectric panels joined by means of dielectric seams.

The dielectric substrate 6002, 7002, 8002, or the dielectric panels if the dielectric substrate 6002, 7002, 8002 is made of several dielectric panels, may be a bulk material, e.g. plastic membrane, a fibres reinforced composite material or layered material. In preferred embodiments, it may be a woven fabric, preferably an inorganic/organic mixed woven fabric. Examples of woven fabric may be PTFE woven glass fabric laminates that may further comprise aramid fibers.

In some embodiments, the thickness of the dielectric substrate 6002 may be at least 1 mm, preferably at least 3 mm.

A radome according to the disclosure may be operated within any operating frequency. In preferred embodiments, the operating frequency of the radome may in the Ku-band, i.e. 12 to 18 GHZ, or Ka-band, i.e. 26.5 and 40 GHz. Preferably, the amplitude loss of the active area may be between 0 and 3 dB.

All embodiments described herein may be combined unless they appear technically incompatible. Further, although the invention has been described in connection with preferred embodiments, it should be understood that various modifications, additions and alterations may be made to the invention by one skilled in the art without departing from the spirit and scope of the invention as defined in claims.

### EXAMPLES

The features and the outstanding benefits of a radome according to the disclosure are illustrated by example embodiments which are now described in detail.

In two example embodiments, E1, E2, with reference to [FIG. 6], a radome is made with an electromagnetic wave active area 6001 made of a dielectric substrate 6002 and two dual-polarized meta-surfaces 6003, 6004 disposed on both sides of the dielectric substrate 6002. The dielectric substrate 6002 is a Teflon® woven glass fabric laminate cladded with copper which is sold under the brand name F4BM-1/2 by TAIZHOU WANGLING. The thickness is 3 mm, the dielectric constant is 3.5 and its dissipation factor is 0.002.

The dual-polarized meta-surfaces 6003, 6004 are made of plurality of periodically arranged copper meta-atoms 9001a-z, 10001a-z with open, rotational symmetric, and non-continuous geometrical patterns. They are directly patterned on the copper cladded dielectric substrate dielectric 6002 through chemical etching.

The pattern of the meta-atoms 9001a-z of the first meta-surface 6003 are open sided square and the pattern of the meta-atoms 10001a-z of the second meta-surface 6004 are open angle square, similar to those illustrated on [FIG. 9] and [FIG. 10]. The meta-atoms 9001a-z, 10001a-overlap complementarily between the two sides of the dielectric substrate 6002, and form a complete and closed square, when the patterns are superimposed through the dielectric substrate 6002.

The meta-atoms 9001a-z, 10001a-z are periodically arranged into two groups 6005a-6005b covering one space region R1 of the angular radiation pattern of a planar array antenna 1002. The geometric dimensions (l,s,g,w) of the meta-atoms 9001a-z, 10001a-z vary within each group 6005a-6005b so that to form an electro-magnetic transmissive phase gradient within that group.

In the first example embodiment, E1, the electromagnetic transmissive phase gradient within each of the two groups 6005a-6005b is made of a series of 6 meta-atoms with varying geometric dimensions (l,s,g,w) of their pattern. In the second example embodiment, E2, the electromagnetic transmissive phase gradient within each of the two groups 6005a-6005b is made of a series of 12 meta-atoms. The phase, q, the amplitude loss, A, in dB, the periodicity, Δp, in millimetres, and the geometric dimensions (l,s,g,w) in millimeters of the pattern of each-meta-atoms of each series in each group 6005a-6005b are reported in table 1 for the first example embodiment, E1, and in the table 2 for the second example embodiment, E2. The phase difference, Δφ, is around 60° for the first example embodiment E1, and is around 30° for the second example embodiment E1.

TABLE 1

| | Meta- | | A | Δp | s | w | l | g |
|---|---|---|---|---|---|---|---|---|
| | atom | φ | (dB) | (mm) | (mm) | (mm) | (mm) | (mm) |
| 6005a | 1 | 179.3 | −1.8 | 9.35 | 8.64 | 0.36 | 5.75 | 2.75 |
| | 2 | 126.4 | −1.1 | 9.35 | 8.64 | 0.36 | 5.75 | 2 |
| | 3 | 60 | −1 | 9.35 | 8.64 | 0.36 | 6.1 | 1.75 |
| | 4 | 6.02 | −0.3 | 9.35 | 8.64 | 0.36 | 6.5 | 1.5 |
| | 5 | −55.9 | −1.6 | 9.35 | 8.64 | 0.36 | 7.5 | 0.5 |
| | 6 | −121.3 | −1 | 9.35 | 8.64 | 0.36 | 4 | 3 |
| 6005b | 1 | 175 | −1.11 | 10.2 | 8.2 | 0.36 | 5.5 | 1.7 |
| | 2 | 116.42 | −3.7 | 10.2 | 8.2 | 0.36 | 6.1 | 1.8 |
| | 3 | 52.3 | −1.9 | 10.2 | 8.2 | 0.36 | 6.4 | 1.2 |
| | 4 | 2.64 | −0.36 | 10.2 | 8.2 | 0.36 | 6.7 | 1.1 |
| | 5 | −63.43 | −3 | 10.2 | 8.2 | 0.36 | 3.7 | 3 |
| | 6 | −124.8 | −0.5 | 10.2 | 8.2 | 0.36 | 5.1 | 2.3 |

TABLE 2

| | Meta- | | A | p | s | w | l | g |
|---|---|---|---|---|---|---|---|---|
| | atom | φ | (dB) | (mm) | (mm) | (mm) | (mm) | (mm) |
| 6005a | 1 | −147.6 | −0.45 | 9.35 | 8.64 | 0.36 | 5 | 2.5 |
| | 2 | −121.3 | −1 | 9.35 | 8.64 | 0.36 | 4 | 3 |
| | 3 | −84.8 | −2.6 | 9.35 | 8.64 | 0.36 | 2.5 | 0.5 |
| | 4 | −55.9 | −1.6 | 9.35 | 8.64 | 0.36 | 7.5 | 0.5 |
| | 5 | −29.3 | −2.5 | 9.35 | 8.64 | 0.36 | 6.5 | 0.5 |
| | 6 | 6.02 | −0.3 | 9.35 | 8.64 | 0.36 | 6.5 | 1.5 |
| | 7 | 33.9 | −0.93 | 9.35 | 8.64 | 0.36 | 6.5 | 1.75 |
| | 8 | 60 | −1 | 9.35 | 8.64 | 0.36 | 6.1 | 1.75 |
| | 9 | 84.2 | −3 | 9.35 | 8.64 | 0.36 | 6.25 | 2 |
| | 10 | 126.4 | −1.1 | 9.35 | 8.64 | 0.36 | 5.75 | 2 |
| | 11 | 153.2 | −0.6 | 9.35 | 8.64 | 0.36 | 5.75 | 2.25 |
| | 12 | 179.3 | −1.8 | 9.35 | 8.64 | 0.36 | 5.75 | 2.75 |
| 6005b | 1 | −148.48 | −0.1 | 10.2 | 8.2 | 0.36 | 5.4 | 2 |
| | 2 | −124.8 | −0.5 | 10.2 | 8.2 | 0.36 | 5.1 | 2.3 |
| | 3 | −87 | −0.8 | 10.2 | 8.2 | 0.36 | 4.1 | 3.2 |
| | 4 | −63.43 | −3 | 10.2 | 8.2 | 0.36 | 3.7 | 3 |
| | 5 | −28.24 | −1.08 | 10.2 | 8.2 | 0.36 | 6.9 | 0.9 |
| | 6 | 2.64 | −0.36 | 10.2 | 8.2 | 0.36 | 6.7 | 1.1 |
| | 7 | 29.5 | −0.8 | 10.2 | 8.2 | 0.36 | 6.6 | 1.2 |
| | 8 | 52.3 | −1.9 | 10.2 | 8.2 | 0.36 | 6.4 | 1.2 |
| | 9 | 90 | −4.7 | 10.2 | 8.2 | 0.36 | 6.2 | 1.3 |
| | 10 | 116.42 | −3.7 | 10.2 | 8.2 | 0.36 | 6.1 | 1.8 |
| | 11 | 156 | −2.08 | 10.2 | 8.2 | 0.36 | 6 | 1.8 |
| | 12 | 175 | −1.11 | 10.2 | 8.2 | 0.36 | 5.5 | 1.7 |

In each group, each series of meta-atoms is replicated three times in the direction corresponding to the radiation direction of the covered region R1, and replicated three times in the perpendicular direction. In other words, each group of the first example embodiment, E1, contains 54 (3×3×6) meta-atoms, and each group of the first example embodiment, E2, contains 108 (3×3×12) meta-atoms.

In a third example, E3, with reference to [FIG. 8], a radome is made with an electro-magnetic wave active area 8001 made of a dielectric substrate 8002 and two dual-polarized meta-surfaces 8003, 8004 disposed on both sides of the dielectric substrate 8002. The dielectric substrate 8002 is a Teflon® woven glass fabric laminate cladded with copper which is sold under the brand name F4BM-1/2 by TAIZHOU WANGLING. The thickness is 3 mm, the dielectric constant is 3.5 and its dissipation factor is 0.002.

The dual-polarized meta-surfaces 8003, 8004 are made of plurality of periodically arranged copper meta-atoms 9001a-z, 10001a-z with open, rotational symmetric, and non-continuous geometrical patterns. They are directly patterned on the copper cladded dielectric substrate dielectric 8002 through chemical etching.

The pattern of the meta-atoms 9001a-z of the first meta-surface 8003 are open sided square and the pattern of the meta-atoms 10001a-z of the second meta-surface 6004 are open angle square, similar to those illustrated on [FIG. 9] and [FIG. 10]. The meta-atoms 9001a-z, 10001a-overlap complementarily between the two sides of the dielectric substrate 8002, and form a complete and closed square, when the patterns are superimposed through the dielectric substrate 6002.

The meta-atoms 9001a-z, 10001a-z are periodically arranged into two groups 8005a-8005b covering one space region R1 of the angular radiation pattern of a planar array antenna 1002. The geometric dimensions (l,s,g,w) of the meta-atoms 9001a-z, 10001a-z vary within each group 8005a-8005b so that to form an electro-magnetic transmissive phase gradient within that group.

The active area 8001 further comprises a group 8007 of meta-atoms whose geometric dimensions does not vary, i.e., there is no transmissive phase gradient. The electro-magnetic transmissive phase gradient within the group 8005a is made of a series of 6 meta-atoms with varying geometric dimensions (l,s,g,w) of their pattern. The electro-magnetic transmissive phase gradient within the 8005b is made of a series of 12 meta-atoms with varying geometric dimensions (l,s,g,w) of their pattern. The phase, φ, the amplitude loss, A, in dB, the periodicity, Δp, in millimetres, and the geometric dimensions (l,s,g,w) in millimeters of the pattern of each-meta-atoms of each series in each group 6005a-6005b are reported in table 3. The phase difference, Δφ, is around 60° for the group 8005a, and is around 30° for the group 8005b.

TABLE 3

| | Meta- | | A | p | s | w | l | g |
|---|---|---|---|---|---|---|---|---|
| | atom | φ | (dB) | (mm) | (mm) | (mm) | (mm) | (mm) |
| 8007 | 1 | 179.3 | −1.8 | 9.35 | 8.64 | 0.36 | 5.75 | 2.75 |
| 8005a | 1 | 174.27 | −0.46 | 10 | 8.6 | 0.36 | 5.8 | 2.2 |
| | 2 | 124.64 | −1.2 | 10 | 8.6 | 0.36 | 5.8 | 1.9 |
| | 3 | 60.8 | −0.63 | 10 | 8.6 | 0.36 | 6.25 | 1.7 |
| | 4 | 2.1 | −0.76 | 10 | 8.6 | 0.36 | 6.5 | 1.5 |
| | 5 | −51.9 | −1.86 | 10 | 8.4 | 0.36 | 7.2 | 0.6 |
| | 6 | −126.9 | −0.49 | 10 | 8.4 | 0.36 | 5.65 | 2.8 |
| 8005b | 1 | 175 | −1.11 | 10.2 | 8.2 | 0.36 | 5.5 | 1.7 |
| | 2 | 156 | −2.08 | 10.2 | 8.2 | 0.36 | 6 | 1.8 |
| | 3 | 116.42 | −3.7 | 10.2 | 8.2 | 0.36 | 6.1 | 1.8 |
| | 4 | 90 | −4.7 | 10.2 | 8.2 | 0.36 | 6.2 | 1.3 |
| | 5 | 52.3 | −1.9 | 10.2 | 8.2 | 0.36 | 6.4 | 1.2 |
| | 6 | 29.5 | −0.8 | 10.2 | 8.2 | 0.36 | 6.6 | 1.2 |
| | 7 | 2.64 | −0.36 | 10.2 | 8.2 | 0.36 | 6.7 | 1.1 |
| | 8 | −28.24 | −1.08 | 10.2 | 8.2 | 0.36 | 6.9 | 0.9 |
| | 9 | −63.43 | −3 | 10.2 | 8.2 | 0.36 | 3.7 | 3 |
| | 10 | −87 | −0.8 | 10.2 | 8.2 | 0.36 | 4.1 | 3.2 |
| | 11 | −124.8 | −0.5 | 10.2 | 8.2 | 0.36 | 5.1 | 2.3 |
| | 12 | −148.48 | −0.1 | 10.2 | 8.2 | 0.36 | 5.4 | 2 |

For comparison, in two counterexamples, CE1, CE2, with reference to [FIG. 1], [FIG. 2], [FIG. 3] and [FIG. 4], a radome is made with an electromagnetic wave active area 1001 made of a dielectric substrate 2000 and two dual-polarized meta-surfaces 2002, 2003 disposed on both sides of the dielectric substrate 2000. The dielectric substrate 2000 is the same as for the example embodiments E1, E2 and E3.

The active area comprises only one group of a plurality of copper meta-atoms 3001a-z, 4001a-z with open, rotational symmetric, and non-continuous geometrical patterns As for the two example embodiments E1, E2, the meta-atoms are directly patterned on the copper cladded dielectric substrate dielectric 2000 through chemical etching.

The meta-atoms patterns are open sided squares on the top surface 2002 and open angle squares on the bottom surface 2003. The meta-atoms are uniform, i.e., their geometric dimensions (l,s,g,w) do not vary. The phase, φ, the amplitude loss, A, in dB, the periodicity, Δp, in millimetres, and the geometric dimensions (l,s,g,w) in millimeters of the pattern are reported in table 4 for the two counterexamples CE1 and CE2.

TABLE 4

| | Meta- | | A | Δp | s | w | l | g |
|---|---|---|---|---|---|---|---|---|
| | atom | φ | (dB) | (mm) | (mm) | (mm) | (mm) | (mm) |
| CE1 | 1 | 179.3 | −1.8 | 9.35 | 8.64 | 0.36 | 5.75 | 2.75 |
| CE2 | 1 | 175 | −1.11 | 10.2 | 8.2 | 0.36 | 5.5 | 1.7 |

A third counterexample, CE3, is made similar to the counterexamples CE1 and CE2 except the geometric dimensions (l,s,g,w) of the meta-atoms 3001a-z, 4001a-z vary so that to form a transmissive phase gradient. The phase, φ, the amplitude loss, A, in dB, the periodicity, Δp, in millimetres, and the geometric dimensions (l,s,g,w) in millimeters of the pattern are reported in table 5.

TABLE 5

| Meta- | | | | | | | |
|---|---|---|---|---|---|---|---|
| atom | φ | A (dB) | p(mm) | s(mm) | w(mm) | l(mm) | g(mm) |
| 1 | −126.9 | −0.49 | 10 | 8.4 | 0.36 | 5.65 | 2.8 |
| 2 | −51.9 | −1.86 | 10 | 8.4 | 0.36 | 7.2 | 0.6 |
| 3 | 2.1 | −0.76 | 10 | 8.6 | 0.36 | 6.5 | 1.5 |
| 4 | 60.8 | −0.63 | 10 | 8.6 | 0.36 | 6.25 | 1.7 |
| 5 | 124.64 | −1.2 | 10 | 8.6 | 0.36 | 5.8 | 1.9 |
| 6 | 174.27 | −0.46 | 10 | 8.6 | 0.36 | 5.8 | 2.2 |

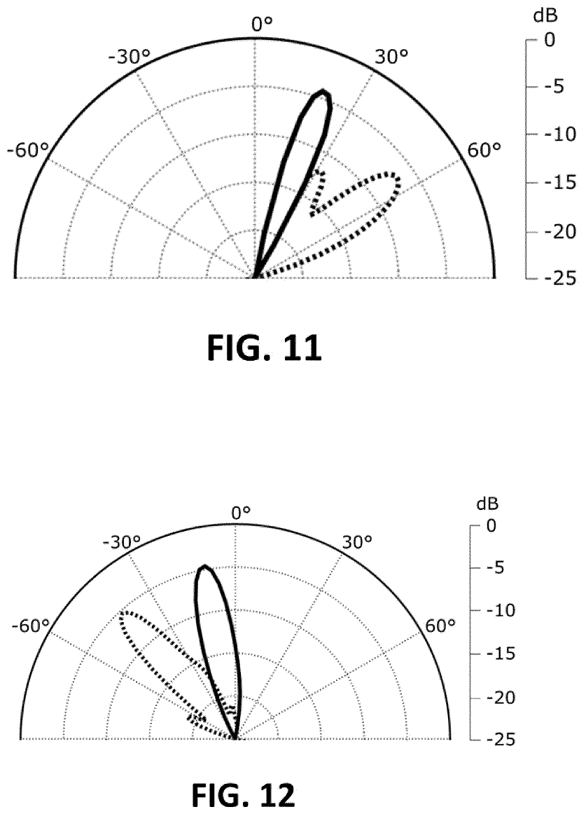

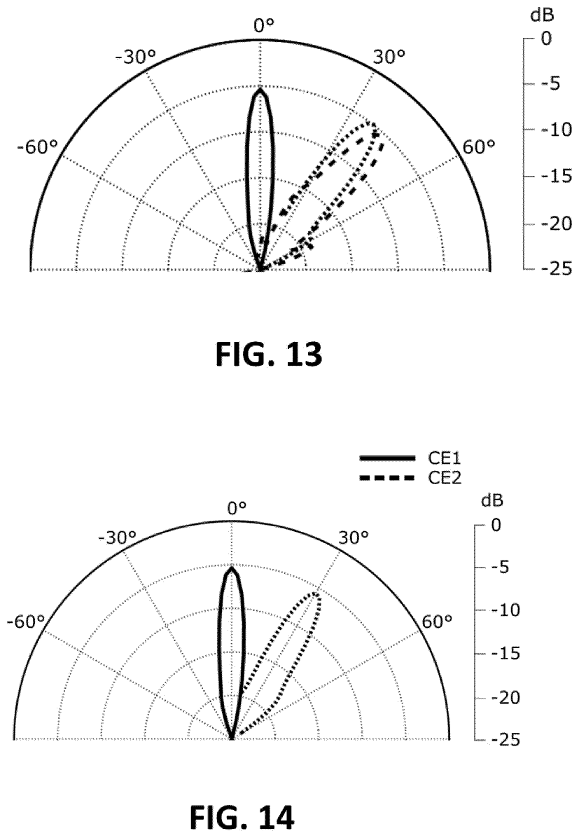

The three example embodiments E1, E2 and E3 and the three counterexamples CE1, CE2, CE3 were set in front of a planar phased array antenna radiating an electro-magnetic beam at 15 GHz. The first example embodiment E1 was exposed to a 0° incident illumination beam and a 30° incident illumination beam. The second example embodiment E2 was exposed to a 0° incident illumination beam and a −30° incident illumination beam. The third example embodiment E3 was exposed to a 0° incident illumination beam, a 15° incident illumination beam, and a 30° incident illumination beam. The transmitted far-field radiation pattern was measured. This pattern is represented on [FIG. 11] for the first example embodiment E1, on the [FIG. 12] for the second example embodiment, E2, and on the [FIG. 13] for the third example embodiment E3.

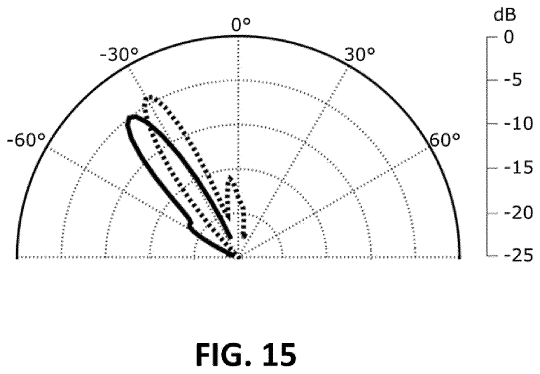

The first counterexample CE1 was exposed to a 0° incident illumination beam and the second counterexample CE2 was exposed to a 30° incident illumination beam. The third counterexample CE3 was exposed to a −15° incident illumination beam and a −30° incident illumination beam. The measured transmitted far-field radiation pattern is represented on [FIG. 14] for both counterexamples CE1 and CE and on the [FIG. 15] for the third counterexample CE3.

Far-field radiation patterns of [FIG. 11], [FIG. 12] and [FIG. 13] clearly show that a radome according to the disclose allows a surface varying refraction angle and may adapt depending on the incident angle of the incident electromagnetic radiation beam. On [FIG. 11], the radome allows to refract a 0° incident electromagnetic wave at around 25° (solid line) and a 30° C. incident electromagnetic wave at around 55° (dotted line). On [FIG. 12], the radome allows to refract a 0° incident electromagnetic wave at around −10° (solid line) and a −30° incident electromagnetic wave at around −40° (dotted line). On [FIG. 13], the radome does not refract a 0° incident electromagnetic wave (solid line) while a 15° incident illumination beam is refracted at around 38° (dotted line) and a 30° incident illumination beam is refracted around 42° (dashed line). The scanning range is extended uniformly whatever the incident angle of the radiation beam.

Far-field radiation patterns of [FIG. 14] shows that the absence of transmissive phase gradient in the two counterexample CE1 (solid line), CE2 (dotted line) does not allow to refract the incident beam. On [FIG. 15], the radome according to the counterexample CE3 refracts a −15° incident illumination beam at −38° C. (solid line) while a −30° illumination beam is not refracted and remains at −30° (dotted line)

The example embodiments clearly show that a radome according to the disclosure allows a surface varying refraction angle and may adapt depending on the incident angle of the incident electromagnetic radiation beam.

1. A radome for a planar array antenna,
wherein said radome comprises at least an electromagnetic wave active area;
wherein said electromagnetic wave active area consists of a dielectric substrate and two dual-polarized meta-surfaces disposed on both sides of the dielectric substrate;
wherein said two dual-polarized meta-surfaces are made of plurality of periodically arranged metallic meta-atoms, each metallic meta-atom consisting of a metallic cell with open, rotational symmetric, and non-continuous geometrical patterns;
wherein said metallic meta-atoms overlap to form a complete and closed pattern when the patterns are superimposed in a plane parallel to the two sides of the dielectric substrate;
wherein said metallic meta-atoms are periodically arranged into at least two preferably three, groups covering all or part of the angular radiation pattern of the planar array antenna;
wherein geometric dimensions of the metallic meta-atoms vary within each group so that to form an electromagnetic transmissive phase gradient within that group,
wherein said electromagnetic transmissive phase gradient is different from one group;
wherein a periodicity of the metallic meta-atoms is between, λ/10 and λ;
wherein λ is the wavelength of an incident electromagnetic wave from the planar array antenna;
wherein the dielectric substrate is a woven fabric, preferably an inorganic/organic mixed woven fabric.

2. The radome according to claim 1, wherein the metallic meta-atoms are arranged in at least first, second and third groups, wherein a phase difference Δp of the transmissive phase gradient, grad φ, is between 0° and 30° for the first group, between 30° and 40° for the second group and between 40° and 50° for the third group, and wherein the first, second and third group are located along said radome so that an incident angle of a planar array antenna is respectively between 0° and 15°, 15° and 30° and 30° and 45° for the first, second and third group.

3. The radome according to claim 1, wherein the transmissive phase gradient, grad φ, within a group may be is positive, negative, or alternating over said group.

4. The radome according to claim 1, wherein a number of metallic meta-atoms within a group is a ratio between 2π and a phase difference, Δφ, in radians of the transmissive phase gradient, grad φ.

5. The radome according to claim 1, wherein the pattern of the metallic meta-atoms of the first meta-surface is open sided square and the pattern of the metallic meta-atoms of the second meta-surface is open angle square.

6. The radome according to claim 5, wherein a side length, of square segments are between λ/200 and λ/20, wherein Δ is the wavelength of the incident electromagnetic wave from the planar array antenna.

7. The radome according to claim 5, wherein a length of the segments of the open angle square is between λ/5 and λ/1.4, wherein λ is the wavelength of the incident electromagnetic wave from the planar array antenna.

8. The radome according to claim 1, wherein a thickness of the dielectric substrate is at least 1 mm.

9. The radome according to claim 1, wherein an operating frequency of said radome is in the Ku-band or Ka-band.

10. The radome according to claim 1, wherein an amplitude loss of the active area is between 0 and 3 dB.

11. The radome according to claim 1, wherein the metallic meta-atoms are made of copper or alloyed copper.

12. The radome according to claim 1, wherein said metallic meta-atoms are periodically arranged into at least three groups covering all or part of the angular radiation pattern of the planar array antenna.

13. The radome according to claim 1, wherein the periodicity of the metallic meta-atoms is between λ/4 and λ/1.3.

14. The radome according to claim 13, wherein the periodicity of the metallic meta-atoms is between λ/2.8 and λ/1.6.

15. The radome according to claim 1, wherein the woven fabric is an inorganic/organic mixed woven fabric.

16. The radome according to claim 6, wherein the side length of the square segments are between λ/100 and λ/40.

17. The radome according to claim 7, wherein the length of the segments of the open angle square is between λ/4.7 and λ/1.8.

18. The radome according to claim 8, wherein the thickness of the dielectric substrate is at least 3 mm.
